(19) United States
(12) Patent Application Publication
(10) Pub. No.: US 2024/0048558 A1
(43) Pub. Date: Feb. 8, 2024

(54) DEVICE AUTHENTICATION METHOD, TERMINAL DEVICE, SERVER, AND COMPUTER DEVICE

(71) Applicant: BOE Technology Group Co., Ltd., Beijing (CN)

(72) Inventors: Peng HU, Beijing (CN); Xiaojun TANG, Beijing (CN); Ning ZHANG, Beijing (CN)

(21) Appl. No.: 18/036,658

(22) PCT Filed: Dec. 25, 2020
(86) PCT No.: PCT/CN2020/139433

§ 371 Date: May 12, 2023

(51) Int. Cl. H04L 9/40

(52) U.S. Cl. CPC H04L 63/0876

(57) ABSTRACT

Disclosed is a device authentication method used in a server, comprising: (S11) receiving a certification request sent by at least one terminal device; (S12) parsing the certification request so as to perform authentication on physical code information of the terminal device according to a preset device table; (S13) in a situation where the physical code information of the terminal device matches a preset terminal device code, determining that the terminal device passes authentication; (S14) in a situation where the physical code information of the terminal device does not match any preset terminal device code in the preset device table and the total number of preset terminal device codes in the preset device table has not reached a threshold, in response to an add-to-device table operation, adding the physical code information of the terminal device to the preset device table and determining that the terminal device passes authentication.

### CROSS-REFERENCE TO RELATED APPLICATION

The present application is a U.S. National Phase Entry of International Application No. PCT/CN2020/139433 having an international filing date of Dec. 25, 2020. The entire contents of the above-identified application are hereby incorporated by reference.

### TECHNICAL FIELD

The present disclosure relates to the field of communication technologies, in particular to a device authentication method, a server, a computer device, and a readable storage medium.

### BACKGROUND

With development of Internet technologies, information security has become an increasingly concerned issue. In a scenario of providing information to different terminal devices, how to carry out accurate and reliable device authentication or identity authentication for terminal devices before providing information has become an urgent technical problem to be solved.

### SUMMARY

In view of this, implementation modes of the present disclosure provide a device authentication method, a server, a computer device, and a readable storage medium.

The present disclosure provides a device authentication method, used for a server, wherein the device authentication method includes following acts: receiving an authentication request sent by at least one terminal device, wherein the authentication request includes physical code information of the terminal device; parsing the authentication request to perform authentication on the physical code information of the terminal device according to a preset device table, wherein the preset device table includes a preset terminal device code; in a case that the physical code information of the terminal device matches the preset terminal device code, determining that the terminal device passes authentication; in a case that the physical code information of the terminal device does not match any preset terminal device code in the preset device table and a total quantity of preset terminal device codes in the preset device table has not reached a threshold, adding the physical code information of the terminal device to the preset device table in response to an operation of adding a device table and determining that the terminal device passes authentication; and in a case that the physical code information of the terminal device does not match any preset terminal device code in the preset device table and the total quantity of preset terminal device codes in the preset device table has reached the threshold, determining that the terminal device fails authentication.

In some implementation modes, in a case of receiving authentication requests sent by a plurality of terminal devices, the server performs authentication on the plurality of terminal devices in a concurrent mode.

In some implementation modes, the authentication request further includes identity feature data used for identity authentication, the device authentication method further includes: after the terminal device passes authentication, performing feature extraction on the identity feature data according to a feature extraction model to obtain target feature data; and performing identity authentication according to the target feature data.

In some implementation modes, the authentication request is sent to the server by means of an Http Post request.

In some implementation modes, the authentication request transmits data in a JavaScript Object Notation (JSON) mode.

In some implementation modes, the authentication request is transmitted after being string-encrypted and encoded.

In some implementation modes, the server includes an identity feature database storing a correspondence between user identity information and target feature data, and the performing identity authentication according to the target feature data includes: acquiring preset identity feature data; and comparing the target feature data with the preset identity feature data to perform identity authentication, establishing user identity information and adding the user identity information and the target feature data to the identity feature database when the identity authentication is successful.

In some implementation modes, the comparing the target feature data with the preset identity feature data to perform identity authentication, establishing the user identity information and adding the user identity information and the target feature data to the identity feature database when the identity authentication is successful includes: in a case that confidence of a comparison result between the target feature data and the preset identity feature data is greater than a first threshold, determining that the identity authentication is successful.

In some implementation modes, the server includes an identity feature database storing a correspondence between user identity information and target feature data, and the performing identity authentication according to the target feature data includes: comparing the target feature data with target feature data in the identity feature database to perform identity authentication, and determining user identity information corresponding to the target feature data when the identity authentication is successful.

In some implementation modes, the comparing the target feature data with the target feature data in the identity feature database to perform identity authentication, and determining the user identity information corresponding to the target feature data when the identity authentication is successful includes: determining that the identity authentication is successful in a case that confidence of a comparison result between the target feature data and the target feature data in the identity feature database is greater than a second threshold.

In some implementation modes, the device authentication method includes: generating an authentication feedback request according to an authentication result or an identity authentication result; and sending the authentication feedback request to a corresponding terminal device.

In some implementation modes, in a case that a plurality of terminal devices pass authentication, the server performs feature extraction on identity feature data corresponding to the plurality of terminal devices in a concurrent mode.

The present disclosure provides a server including: a receiving module, configured to receive an authentication request sent by at least one terminal device, wherein the authentication request includes physical code information of the terminal device; a parsing module, configured to parse the authentication request to perform authentication on the physical code information of the terminal device according to a preset device table, wherein the preset device table includes a preset terminal device code; and an authentication module, configured to determine that the terminal device passes authentication in a case that the physical code information of the terminal device matches the preset terminal device code, respond to an operation of adding a device table and determine that the terminal device passes authentication in a case that the physical code information of the terminal device does not match the preset terminal device code and a quantity of preset terminal device codes has not reached a threshold, and determine that the terminal device fails authentication in a case that the physical code information of the terminal device does not match any preset terminal device code in the preset device table, and the total quantity of preset terminal device codes in the preset device table has reached the threshold.

The present disclosure also provides a computer device including one or more processors and a memory storing a computer program, wherein in a case that the computer program is executed by the processors, acts of the device authentication method of any implementation mode described above are implemented.

The present disclosure also provides a non-volatile computer-readable storage medium storing a computer program, wherein in a case that the computer program is executed by one or more processors, acts of the device authentication method of any implementation mode described above are implemented.

In the device authentication method, the server, the computer device, and the readable storage medium in the present disclosure, security and reliability of communication between a terminal device and a server can be ensured by receiving and parsing an authentication request sent by the terminal device and performing authentication on the terminal device according to a preset device table.

### BRIEF DESCRIPTION OF DRAWINGS

The above and/or additional aspects and advantages of the present disclosure will become apparent and easy to understand from following description of implementation modes in conjunction with accompanying drawings.

FIG. 1 is a schematic diagram of a flow of a device authentication method according to some implementation modes of the present disclosure.

FIG. 2 is a schematic diagram of a structure of a computer device according to some implementation modes of the present disclosure.

FIG. 3 is a schematic diagram of modules of a server according to some implementation modes of the present disclosure.

FIG. 4 is a schematic diagram of a flow of a device authentication method according to some implementation modes of the present disclosure.

FIG. 5 is a schematic diagram of a flow of a device authentication method according to some implementation modes of the present disclosure.

FIG. 6 is a schematic diagram of a flow of a device authentication method according to some implementation modes of the present disclosure.

### DETAILED DESCRIPTION

Hereinafter, implementation modes of the present disclosure will be described in detail, examples of which are illustrated in the accompanying drawings, wherein same or similar reference numerals throughout the description indicate same or similar elements or elements having same or similar functions. The implementation modes described below with reference to the accompanying drawings are illustrative, and are merely intended to explain the present disclosure, which cannot be interpreted as a limitation on the present disclosure.

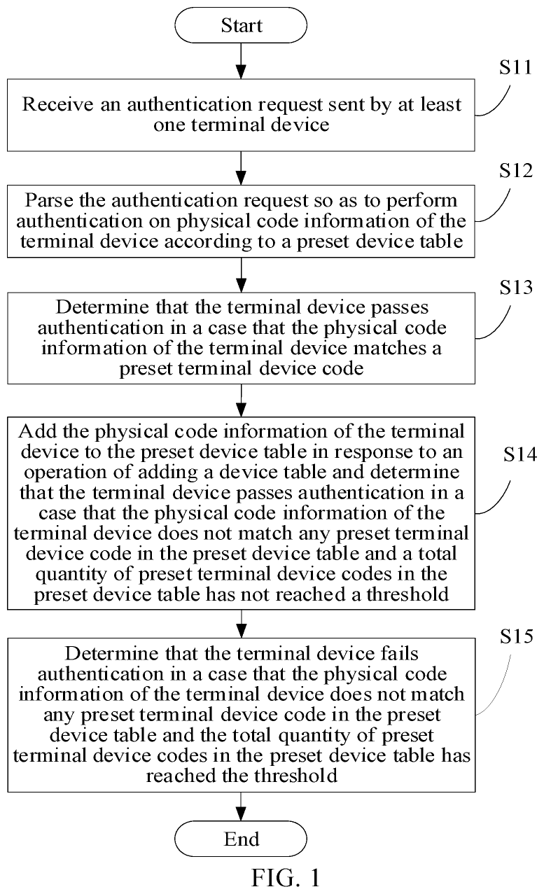

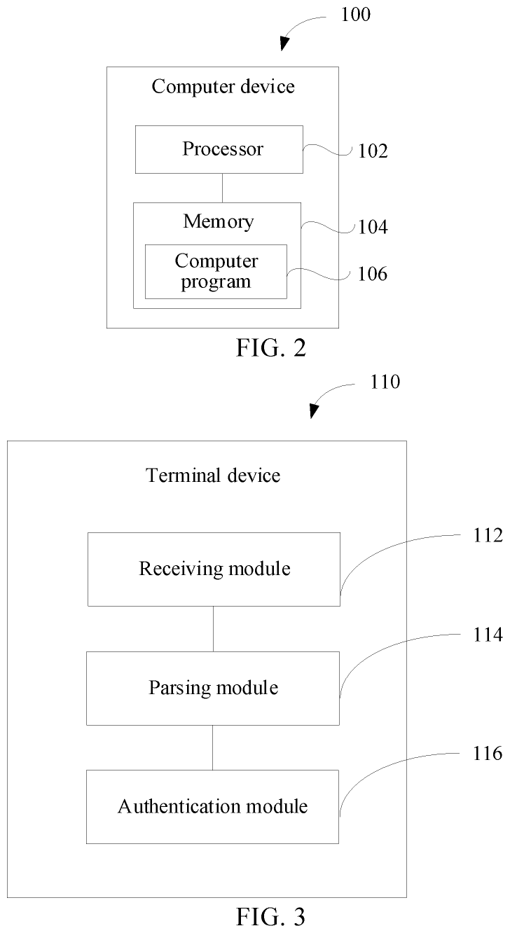

Referring to FIG. 1 to FIG. 3, the present disclosure provides a device authentication method used for a server 110, the device authentication method including following acts.

S11: receiving an authentication request sent by at least one terminal device.

S12: parsing the authentication request so as to perform authentication on physical code information of the terminal device according to a preset device table.

S13: in a case that the physical code information of the terminal device matches a preset terminal device code, determining that the terminal device passes authentication.

S14: in a case that the physical code information of the terminal device does not match any preset terminal device code in the preset device table and a total quantity of preset terminal device codes in the preset device table has not reached a threshold, in response to an operation of adding a device table, adding the physical code information of the terminal device to the preset device table and determining that the terminal device passes authentication.

S15: in a case that the physical code information of the terminal device does not match any preset terminal device code in the preset device table and the total quantity of preset terminal device codes in the preset device table has reached the threshold, determining that the terminal device fails authentication.

An implementation mode of the present disclosure provides a computer device 100. The computer device 100 includes a processor 102 and a memory 104, the memory 104 stores a computer program 106 which, when executed by the processor 102, implements following acts: receiving an authentication request sent by at least one terminal device; parsing the authentication request so as to perform authentication on physical code information of the terminal device according to a preset device table; in a case that the physical code information of the terminal device matches a preset terminal device code, determining that the terminal device passes authentication; in a case that the physical code information of the terminal device does not match any preset terminal device code in the preset device table and a total quantity of preset terminal device codes in the preset device table has not reached a threshold, in response to an operation of adding a device table, adding the physical code information of the terminal device to the preset device table and determining that the terminal device passes authentication; in a case that the physical code information of the terminal device does not match any preset terminal device code in the preset device table, and the total quantity of preset terminal device codes in the preset device table has reached the threshold, determining that the terminal device fails authentication. Herein, the processor 102 may be a processor separately disposed by the computer device 100 for implementing the device authentication method or may be a processor of the computer device 100 itself, which is not limited specifically.

An implementation mode of the present disclosure also provides a server 110, and a device authentication method according to an implementation mode of the present disclosure may be implemented by the server 110. The server 110 includes a receiving module 112, a parsing module 114, and an authentication module 116. S11 may be implemented by the receiving module 112, S12 may be implemented by the parsing module 114, and S13 to S15 may be implemented by the authentication module 116. Or, the receiving module 112 is configured to receive an authentication request sent by at least one terminal device, the parsing module 114 is configured to parse the authentication request so as to perform authentication on physical code information of the terminal device according to a preset device table, the authentication module 116 is configured to determine that the terminal device passes authentication in a case that the physical code information of the terminal device matches a preset terminal device code, add the physical code information of the terminal device to the preset device table and determine that the terminal device passes authentication in response to an operation of adding a device table in a case that the physical code information of the terminal device does not match any preset terminal device code in the preset device table and a total quantity of preset terminal device codes in the preset device table has not reached a threshold, and determine that the terminal device fails authentication in a case that the physical code information of the terminal device does not match the preset terminal device code and a quantity of the preset terminal device codes has reached the threshold.

Specifically, in the device authentication method, the computer device 100, and the server 110 of the present disclosure, by receiving and parsing the authentication request sent by the terminal device and performing authentication on the terminal device according to the preset device table, security and reliability of communication between the terminal device and the server 110 may be ensured.

Further, the authentication request includes physical code information of the terminal device, wherein the physical code information may be an identifier for identifying device feature or uniqueness of the terminal device, such as a hardware-specific number, an international mobile device identification code, a media access control address of the terminal device, etc., and the physical code information is used for authentication between the server 110 and the terminal device. The terminal device may be a smart phone, a tablet computer, a personal computer, an Automated Teller Machine, an entrance gate, a camera, and another device.

The preset device table includes a preset terminal device code, which may be set according to the physical code information of the terminal device. It should be noted that a quantity of preset terminal device codes included in the preset device table may be fixed or not fixed.

In some embodiments, the quantity of preset terminal device codes included in the preset device table is fixed, that is to say, only a preset quantity of preset terminal device codes may be added to the preset device table. The preset quantity may be set according to a usage scenario of identity authentication, performance of a processor of the server 110, user requirements, and another parameter, which is not limited specifically. For example, the quantity of preset terminal device codes in the preset device table may be set to 100, 200, 300, 500, etc.

In this way, the quantity of preset terminal device codes in the preset device table may be kept relatively stable, and security and stability of the server 110 may be maintained.

In other embodiments, the quantity of preset terminal device codes included in the preset device table is not fixed, that is to say, the quantity of preset terminal device codes added to the preset device table may be changed randomly.

In this way, various application occasions of device authentication can be dealt with flexibly, scope of application can be expanded, and user experience can be optimized.

After receiving the authentication request sent by the terminal device, the server 110 parses the authentication request, that is, matches the physical code information of the terminal device in the authentication request with the preset terminal device code, and determines whether the terminal device passes authentication according to a matching result. It may be understood that the physical code information matches the preset terminal device code, which may mean that the physical code information is completely consistent with the preset terminal device code, or may mean that the preset terminal device code includes all of the physical code information, or that the physical code information includes all of the preset terminal device code.

In some embodiments, the physical code information of the terminal device matches the preset terminal device code, and the server 110 determines that the terminal device passes authentication.

In some embodiments, the physical code information of the terminal device does not match the preset terminal device code, and a quantity of preset terminal device codes included in the preset device table is fixed, and a quantity of preset terminal device codes stored in the preset device table is less than a preset quantity. Since the physical code information of the terminal device does not match the preset terminal device code, that is to say, the physical code information of the terminal device is not stored in the preset device table, and the terminal device does not pass authentication. At this time, the server 110 adds the physical code information of the terminal device to the preset device table according to an operation of adding a device table and determines that the terminal device passes authentication.

In other embodiments, the physical code information of the terminal device does not match the preset terminal device code, and a quantity of preset terminal device codes included in the preset device table is fixed, and a quantity of preset terminal device codes stored in the preset device table is greater than or equal to a preset quantity. Since the physical code information of the terminal device does not match the preset terminal device code, that is to say, the physical code information of the terminal device is not stored in the preset device table, the terminal device does not pass authentication, and the quantity of preset terminal device codes stored in the preset device table has reached the preset quantity, then it is determined that the terminal device fails authentication.

In this way, the quantity of preset terminal device codes in the preset device table can be kept relatively stable, and the security and stability of the server 110 may be maintained.

In some implementation modes, the device authentication method includes following acts.

S16: in a case that authentication requests sent by a plurality of terminal devices are received, performing authentication on the plurality of terminal devices using a concurrent mode.

In some implementation modes, S16 may be implemented by the authentication module 116. In other words, the authentication module 116 is configured to perform authentication on a plurality of terminal devices using a concurrent mode in a case of receiving authentication requests sent by the plurality of terminal devices.

In some implementation modes, the processor 102 is configured to perform authentication on a plurality of terminal devices using a concurrent mode in a case of receiving authentication requests sent by the plurality of terminal devices.

Specifically, it may be considered that in a concurrent mode, the server 110 may simultaneously respond to authentication requests of the plurality of terminal devices, and it may be understood that the terminal device herein may be any terminal device. After the terminal device passes authentication, the server 110 in the concurrent mode may simultaneously respond to data processing requests of the plurality of terminal devices which pass authentication.

In this way, an efficiency of authentication can be improved, time for a user to wait for an authentication result can be shortened, and user experience can be optimized.

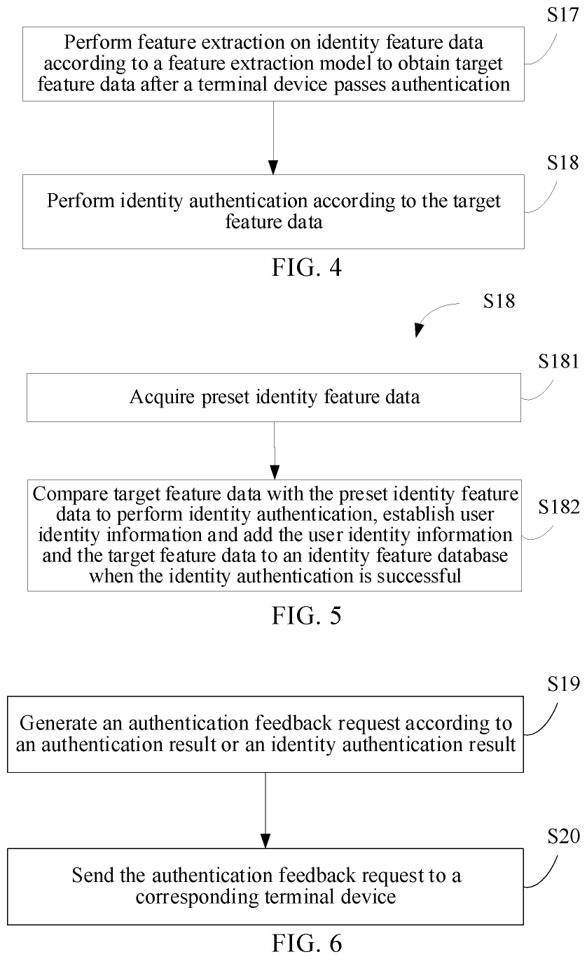

Referring to FIG. 4, in some implementation modes, the authentication request further includes identity feature data for identity authentication. The device authentication method includes following acts.

S17: after the terminal device passes authentication, performing feature extraction on the identity feature data according to a feature extraction model to obtain target feature data.

S18: performing identity authentication according to the target feature data.

In some implementation modes, S17 and S18 may be implemented by the authentication module 116. In other words, the authentication module 116 is configured to perform feature extraction on the identity feature data according to the feature extraction model to obtain target feature data after the terminal device passes authentication, and perform identity authentication according to the target feature data.

In some implementation modes, the processor 102 is configured to perform feature extraction on the identity feature data according to the feature extraction model to obtain target feature data after the terminal device passes authentication, and perform identity authentication according to the target feature data.

Specifically, a model based on convolutional neural network may be adopted for the feature extraction model. In this way, learning from a large number of samples can be effectively carried out, a complicated feature extraction process can be avoided, so that a speed of processing identity feature data is faster, and time for a user to wait for an identity authentication result is shortened.

The identity feature data in the feature extraction model may be stored in a form of a JSON string. In a JSON string, a request instruction may be added flexibly to call different data, which is suitable for multi-occasion application of the device authentication method, and a specific application mode is not limited. For example, an instruction requesting to call data representing a gender of a person in the identity feature data may be added, the data representing the gender of the person may be called for service recommendation and other operations. In this way, various usage scenarios can be taken into account, and application occasions of the device authentication method can be expanded.

The identity feature data may be data that can be used for identifying an identity of a person, such as face image data, fingerprint data, voiceprint data, and/or pupil data, which is not limited specifically. The target feature data may be some feature information in the identity feature data, which is used for identifying an identity of a specific person.

In some embodiments, the identity feature data is face image data. The feature extraction model is used for performing feature extraction on the face image data, face features may be converted into a plurality of data, i.e., target feature data, and the target feature data is stored in the server 110. For example, 512-dimensional data is extracted and stored as target feature data in the server 110. In this way, an effect of facilitating subsequent identity feature comparison can be achieved.

Further, in a case that the identity feature data is the face image data, the terminal device performs detection on a face image according to a face position detection model to obtain a face position box, performs detection on the face image where the face position box is located according to a face key point detection model to obtain face key points, processing the face key points to obtain front face image data, performs detection on the face image according to a face angle detection model to obtain a face deflection angle, and determines target front face image data according to the front face image data and the face deflection angle. Herein, the processing the face key points includes acquiring reference key point data of a front face at a preset size, and calculating and obtaining the front face image data using coordinate point interpolation transformation in a spatial domain according to the reference key point data and the face key points.

Specifically, the terminal device performs detection on the face image according to the face position detection model, and the face position box can be obtained. The face position box may represent a position of a face in the face image, which is convenient for subsequent detection of the face key points and detection of the face deflection angle.

In the face position detection model, confidence of the face position box may be set, so that good balance may be achieved between a recall rate of face position detection and precision of the face position detection, that is to say, the precision of the face position detection is also relatively high in a case that the recall rate of the face position detection is relatively high. Herein, the confidence may be used for characterizing reliability of a face recognition result. Relatively speaking, the higher the confidence is, the higher the reliability of the face recognition result is. On the contrary, the lower the confidence is, the lower the reliability of the face recognition result is. It may be considered that the recall rate of the face position detection represents a recall ratio of a face position in the face image, and the precision of the face position detection represents accuracy of calibrating the face position in the face image.

For example, the confidence of the face position box is set to 0.9, so that the recall rate of the face position detection is greater than 0.99, and the precision of the face position detection is greater than 0.98, that is to say, the recall ratio of the face position in the face image and the precision of calibrating the face position in the face image are both relatively high. In this way, accurate recognition of the face image can be achieved, and user experience can be optimized in practical use.

Furthermore, according to the face key point detection model, the face image where the face position box is located is detected to obtain the face key points, and the face key points are processed, and the front face image data can be obtained. Herein, the face key points may be five points: two eye centers, two corners of a mouth, and a tip of a nose, or contours of three organs: eyes, a nose, and a mouth, or contours of one or more parts of eyebrows, eyes, a nose, a mouth, and a lower mandible, which is not limited specifically.

In the face key point detection model, according to the face position box obtained after the face position detection model is processed, the face key points are detected in the face image where the face position box is located, and the face key points are processed to obtain the front face image data.

In the face angle detection model, according to the face position box obtained after the face position detection model is processed and the face key points obtained after the face key point detection model is processed, it is determined whether a face deflection angle exceeds a predetermined deflection angle threshold, and a face image whose face deflection angle does not exceed the deflection angle threshold is determined. It should be noted that the deflection angle threshold may be set according to detection precision of the face angle detection model, a usage scenario of face angle detection, and another parameter, which is not limited specifically. For example, an angle range is 15 degrees to 30 degrees, and specifically it may be 15 degrees, 20 degrees, 25 degrees, 30 degrees, etc. In other embodiments, the face angle detection model may directly obtain the face deflection angle, and the face image is processed according to different face deflection angles.

Finally, according to the face image whose face deflection angle selected according to the face angle detection model does not exceed the deflection angle threshold, corresponding front face image data in the face key point detection model is determined as the target front face image data.

In addition, a model based on convolution neural network may be adopted for the face position detection model, the face key point detection model, and the face angle detection model. In this way, learning from a large number of samples can be effectively carried out, a complicated feature extraction process can be avoided, so that a speed of processing a face image is faster, and time for a user to wait for an identity authentication result is shortened.

In this way, a face in the face image is detected through a plurality of detection models, and target front face image data is obtained, and accurate recognition of the face image is achieved.

Furthermore, when the face key points are processed, reference key point data of a front face at a preset size is obtained first, and the reference key point data and the face key point are calculated using a coordinate point interpolation transformation method in a spatial domain to obtain front face image data.

Herein, the preset size may be set according to a usage scenario of identity authentication, precision of face detection, and another parameter, which is not limited specifically, for example, it may be 112*112, 224*112, 40*40, 60*40, and another size. The reference key point data may be obtained by providing a large amount of data in advance, machine learning, and so on. An interpolation transformation method may be a nearest neighbor element method, a bilinear interpolation method, a cubic interpolation method, etc., which may be set according to a usage scenario of identity authentication, precision of face detection, and another parameter, which is not limited specifically.

In this way, a face in the face image is detected through a plurality of detection models, and target front face image data is obtained, and accurate recognition of the face image is achieved.

After the terminal device passes authentication, the server 110 performs feature extraction on identity feature data according to a feature extraction model, obtains target feature data, and performs identity authentication according to the target feature data.

In this way, communication security between the server 110 and the terminal device can be ensured and time for a user to wait for an identity authentication result can be shortened, and user experience can be optimized.

In some implementation modes, the authentication request is sent in a manner of an Http Post request.

Specifically, since Http Post is not cached or stored in a log of the server 110, the authentication request is sent using the Http Post, so that communication security between the server 110 and the terminal device can be ensured. Moreover, since Http Post can send a large amount of data and more data types, sending an authentication request by means of the Http Post request can not only ensure the communication security between the server 110 and the terminal device, but also transmit larger data and take into account more usage scenarios.

In some implementation modes, the authentication request transmits data in a JSON mode.

Specifically, the authentication request may be sent in a form of JavaScript Object Notation (JSON). In a JSON string, a request instruction can be added flexibly to call different data, which is suitable for multi-occasion application of device authentication, and a specific application mode is not limited. For example, an instruction requesting to call data representing a gender of a person in identity feature data may be added, to call the data representing the gender of the person for service recommendation and other operations.

In this way, the device authentication can take into account various usage scenarios, and application occasions of the device authentication method are expanded.

In some implementation modes, the authentication request is transmitted after being string-encrypted and encoded.

Specifically, the authentication request is transmitted after being string-encrypted and encoded in the server 110. For example, an encryption encoding method such as base64, base32, and base16 may be used. In this way, the communication security between the server 110 and the terminal device can be further ensured.

Referring to FIG. 5, in some implementation modes, the server 110 includes an identity feature database storing a correspondence between user identity information and target feature data, S18 includes following acts.

S181: acquiring preset identity feature data.

S182: comparing target feature data with the preset identity feature data to perform identity authentication, establishing user identity information and adding the user identity information and the target feature data to the identity feature database when the identity authentication is successful.

In some implementation modes, S181 and S182 may be implemented by the authentication module 116. In other words, the authentication module 116 is configured to acquire preset identity feature data, and compare the target feature data with the preset identity feature data to perform identity authentication, establish the user identity information and add the user identity information and the target feature data to the identity feature database when the identity authentication is successful.

In some implementation modes, the processor 102 is configured to acquire preset identity feature data, and compare the target feature data with the preset identity feature data to perform identity authentication, establish the user identity information and add the user identity information and the target feature data to the identity feature database when the identity authentication is successful.

Specifically, the preset identity feature data is used for comparison with the target feature data, and the preset identity feature data is set according to a type of the target feature data, and may be, for example, face image data, fingerprint data, voiceprint data, and/or pupil data, etc., which is not limited specifically. The preset identity feature data may be obtained by accessing another server 110 or another terminal device, or may be preset identity data stored locally in the server 110.

The target feature data is compared with the preset identity feature data so as to perform identity authentication. When the identity authentication is successful, the user identity information is established, and the user identity information and the target feature data are added to the identity feature database. Herein, the user identity information may be set according to a usage scenario of identity authentication, and user requirements, etc., for example, it may be an employee number, a medical insurance card number, an identity card number, and other information.

In some embodiments, the target feature data is face feature data, and the preset identity feature data is face feature data in an identification photo. The face image data is compared with face feature data in the identification photo so as to perform identity authentication. When the identity authentication is successful, user identity information is established, and the user identity information and the target feature data are added to the identity feature database.

In this way, the identity authentication is performed on the target feature data according to the preset identity feature data, which can ensure reliability of an authentication result. When the identity authentication is successful, the user identity information and the target feature data are added to the identity feature database, and corresponding user identity information can be quickly found during subsequent identity authentication, time for a user to wait can be shortened, and user experience can be optimized.

In some implementation modes, S182 includes a following act.

S1821: determining that identity authentication is successful in a case that confidence of a comparison result between the target feature data and the preset identity feature data is greater than a first threshold.

In some implementation modes, S1821 may be implemented by the authentication module 116. In other words, the authentication module 116 is configured to determine that identity authentication is successful in a case that confidence of a comparison result between the target feature data and the preset identity feature data is greater than a first threshold.

In some implementation modes, the processor 102 is configured t determine that identity authentication is successful in a case that confidence of a comparison result between the target feature data and the preset identity feature data is greater than a first threshold.

Specifically, the first threshold may be set according to a usage scenario of identity authentication, a type of the preset identity feature data, user requirements, and another parameter, which is not limited specifically, for example, it may be 0.7, 0.75, 0.8, 0.85, 0.9, 0.99, and another threshold. The first threshold may be used for characterizing similarity between the target feature data and the preset identity feature data. It may be considered that the higher the first threshold is, the higher the similarity between the target feature data and the preset identity feature data is, that is, the higher the probability that a user corresponding to the target feature data and a user corresponding to the preset identity feature data are a same person. On the contrary, the lower the first threshold is, the lower the similarity between the target feature data and the preset identity feature data is, that is, the lower the probability that a user corresponding to the target feature data and a user corresponding to the preset identity feature data are a same person is.

In a case that the confidence of the comparison result between the target feature data and the preset identity feature data is greater than the first threshold, it is determined that identity authentication is successful, in this way, precision and reliability of an identity authentication result can be further ensured, user information security can be guaranteed, and user experience can be optimized.

In some implementation modes, the server 110 includes an identity feature database storing a correspondence between user identity information and target feature data, S18 includes a following act.

S183: comparing the target feature data with target feature data in the identity feature database to perform identity authentication, and determining user identity information corresponding to the target feature data when the identity authentication is successful.

In some implementation modes, S183 may be implemented by the authentication module 116. In other words, the authentication module 116 is configured to compare the target feature data with target feature data in the identity feature database to perform identity authentication, and determine user identity information corresponding to the target feature data when the identity authentication is successful.

In some implementation modes, the processor 102 is configured to compare the target feature data with target feature data in the identity feature database to perform identity authentication, and determine user identity information corresponding to the target feature data when the identity authentication is successful.

Specifically, the target feature data is compared with target feature data in the identity feature database so as to perform identity authentication, and when the identity authentication is successful, user identity information corresponding to the target feature data is determined.

In some embodiments, the target feature data is face image data. The face image data is compared with face image data in the identity feature database to perform identity authentication, and when the identity authentication is successful, user identity information corresponding to the target feature data is determined.

In this way, identity authentication is performed on the target feature data according to target feature data in the identity feature database, reliability of an authentication result can be ensured, and user identity information corresponding to the target feature data is determined when the identity authentication is successful, time for a user to wait is shortened, and user experience is optimized.

In some implementation modes, S183 includes a following act.

S1831: determining that identity authentication is successful in a case that confidence of a comparison result between the target feature data and target feature data in the identity feature database is greater than a second threshold.

In some implementation modes, S1831 may be implemented by the authentication module 116. In other words, the authentication module 116 is configured to determine that identity authentication is successful in a case that confidence of a comparison result between the target feature data and target feature data in the identity feature database is greater than a second threshold.

In some implementation modes, the processor 102 is configured to determine that identity authentication is successful in a case that confidence of a comparison result between the target feature data and target feature data in the identity feature database is greater than a second threshold.

Specifically, the second threshold may be set according to a usage scenario of identity authentication, a type of the preset identity feature data, user requirements, and another parameter, which is not limited specifically, for example, it may be 0.7, 0.75, 0.8, 0.85, 0.9, 0.99, and another threshold. The second threshold may be used for characterizing similarity between the target feature data and the preset identity feature data. It may be considered that the higher the second threshold is, the higher the similarity between the target feature data and the preset identity feature data is, that is, the higher the probability that a user corresponding to the target feature data and a user corresponding to the preset identity feature data are a same person is. On the contrary, the lower the second threshold is, the lower the similarity between the target feature data and the preset identity feature data is, that is, the lower the probability that a user corresponding to the target feature data and a user corresponding to the preset identity feature data are a same person.

In a case that the confidence of the comparison result between the target feature data and target feature data in the identity feature database is greater than the second threshold, it is determined that identity authentication is successful, in this way, precision and reliability of an identity authentication result can be further ensured, user information security can be guaranteed, and user experience can be optimized.

Further, considering that the preset identity feature data may not be pre-processed when the preset identity feature data is collected, resulting in some abnormal data, irrelevant data, or erroneous data in the preset identity feature data, so that there are more differences between the preset identity feature data and the target feature data, therefore, the second threshold may be set to be greater than the first threshold. That is to say, when matching the target feature data with target feature data in the identity feature database, a requirement for similarity may be higher, and when matching the target feature data with the preset identity feature data, a requirement for similarity may be appropriately reduced. For example, the first threshold is set to 0.8 and the second threshold is set to 0.9.

In this way, identity authentication can be performed more accurately and user experience can be optimized.

Referring to FIG. 6, in some implementation modes, the device authentication method includes following acts.

S19: generating an authentication feedback request according to an authentication result or an identity authentication result.

S20: sending the authentication feedback request to a corresponding terminal device.

In some implementation modes, S19 to S20 may be implemented by the authentication module 116. In other words, the authentication module 116 is configured to generate an authentication feedback request according to an authentication result or an identity authentication result and send the authentication feedback request to a corresponding terminal device.

In some implementation modes, the processor 102 is configured to generate an authentication feedback request according to an authentication result or an identity authentication result and send the authentication feedback request to a corresponding terminal device.

Specifically, after the target feature data is extracted for the feature extraction model, the server 110 performs identity authentication according to the target feature data, and the target feature data may be first compared with target feature data in the identity feature database, and it is considered that identity authentication is successful in a case that confidence of a comparison result between the target feature data and the target feature data in the identity feature database is greater than the second threshold.

In a case that the confidence of the comparison result between the target feature data and the target feature data in the identity feature database is less than the second threshold, the preset identity feature data is acquired, and the target feature data is compared with the preset identity feature data. In a case that confidence of a comparison result between the target feature data and the preset identity feature data is greater than the first threshold, it is considered that identity authentication is successful.

In a case that the confidence of the comparison result between the target feature data and the preset identity feature data is less than the first threshold, it is considered that identity authentication is unsuccessful.

In some embodiments, the target feature data is face feature data. When the face feature data is compared with face feature data stored in the identity feature database, confidence of a comparison result between the face feature data and the face feature data stored in the identity feature database is greater than the second threshold, identity authentication is successful, a result of successful authentication is returned to the terminal device in a form of an authentication feedback request, and corresponding user identity information is determined according to the target face feature data, and the user identity information is sent to the terminal device.

In this way, a user may query corresponding user identity information simply through face authentication, without carrying a card, or a material, etc., and user experience is optimized.

In other embodiments, the target feature data is face feature data. When the face feature data is compared with face feature data stored in the identity feature database, confidence of a comparison result between the face feature data and the face feature data stored in the identity feature database is less than the second threshold, face feature data in an identification photo is acquired, the face feature data is compared with the face feature data in the identification photo, when a comparison result between the face feature data and the face feature data in the identification photo is greater than the first threshold, identity authentication is successful, user identity information is established, and the user identity information and the target feature data are added to the identity feature database, and the user identity information and the target feature data are bound.

In this way, when a user performs identity authentication subsequently, corresponding user identity information can be found quickly, time for the user to wait is shortened, and user experience is optimized.

In some implementation modes, the device authentication method includes a following act.

S21: performing feature extraction on identity feature data corresponding to a plurality of terminal devices in a concurrent mode in a case that the plurality of terminal devices pass authentication.

In some implementation modes, S21 may be implemented by the authentication module 116. In other words, the authentication module 116 is configured to perform feature extraction on identity feature data corresponding to a plurality of terminal devices in a concurrent mode in a case that the plurality of terminal devices pass authentication.

In some implementation modes, the processor 102 is configured to perform feature extraction on identity feature data corresponding to a plurality of terminal devices in a concurrent mode in a case that the plurality of terminal devices pass authentication.

Specifically, it may be considered that in a concurrent mode, the server 110 can simultaneously respond to authentication requests of a plurality of terminal devices, and it may be understood that the terminal devices herein may be any terminal device. After the terminal devices pass authentication, the server 110 in a concurrent mode can simultaneously respond to data processing requests of the plurality of terminal devices which pass authentication.

In this way, efficiency of authentication can be improved, time for a user to wait for an authentication result can be shortened, and user experience can be optimized.

In the description of the specification, descriptions referring to terms “one implementation mode”, “some implementation modes”, “an exemplary implementation mode”, “an example”, “a specific example”, or “some examples” are intended to indicate that a specific feature, structure, material, or feature described in connection with an implementation mode or example is contained in at least one implementation mode or example of the present disclosure. In this specification, schematic expressions of the above terms do not necessarily refer to a same implementation mode or example. Moreover, a specific feature, structure, material, or feature described may be combined in any one or more implementation modes or examples in a suitable manner.

Although implementation modes of the present disclosure have been illustrated and described, those of ordinary skill in the art may understand that multiple changes, modifications, substitutions, and variations may be made to these implementation modes without departing from principles and purposes of the present disclosure. The scope of the present disclosure is defined by the claims and their equivalents.

1. A device authentication method, used for a server, wherein the device authentication method comprises following acts:
receiving an authentication request sent by at least one terminal device, wherein the authentication request comprises physical code information of the terminal device;
parsing the authentication request to perform authentication on the physical code information of the terminal device according to a preset device table, wherein the preset device table comprises a preset terminal device code;
in a case that the physical code information of the terminal device matches the preset terminal device code, determining that the terminal device passes authentication;
in a case that the physical code information of the terminal device does not match any preset terminal device code in the preset device table and a total quantity of preset terminal device codes in the preset device table has not reached a threshold, adding the physical code information of the terminal device to the preset device table in response to an operation of adding a device table and determining that the terminal device passes authentication; and
in a case that the physical code information of the terminal device does not match any preset terminal device code in the preset device table and the total quantity of preset terminal device codes in the preset device table has reached the threshold, determining that the terminal device fails authentication.

2. The device authentication method according to claim 1, wherein in a case of receiving authentication requests sent by a plurality of terminal devices, the server performs authentication on the plurality of terminal devices in a concurrent mode.

3. The device authentication method according to claim 2, wherein the authentication request further comprises identity feature data used for identity authentication, the device authentication method further comprises:
after the terminal device passes authentication, performing feature extraction on the identity feature data according to a feature extraction model to obtain target feature data; and
performing identity authentication according to the target feature data.

4. The device authentication method according to claim 1, wherein the authentication request is sent by means of an Http Post request.

5. The device authentication method according to claim 4, wherein the authentication request transmits data in a JavaScript Object Notation mode.

6. The device authentication method according to claim 3, wherein the authentication request is transmitted after being string-encrypted and encoded.

7. The device authentication method according to claim 3, wherein the server comprises an identity feature database storing a correspondence between user identity information and target feature data, and the performing identity authentication according to the target feature data comprises:
acquiring preset identity feature data; and
comparing the target feature data with the preset identity feature data to perform identity authentication, establishing user identity information and adding the user identity information and the target feature data to the identity feature database when the identity authentication is successful.

8. The device authentication method according to claim 7, wherein the comparing the target feature data with the preset identity feature data to perform identity authentication, establishing the user identity information and adding the user identity information and the target feature data to the identity feature database when the identity authentication is successful comprises:
in a case that confidence of a comparison result between the target feature data and the preset identity feature data is greater than a first threshold, determining that the identity authentication is successful.

9. The device authentication method according to claim 3, wherein the server comprises an identity feature database storing a correspondence between user identity information and target feature data, and the performing identity authentication according to the target feature data comprises:
comparing the target feature data with target feature data in the identity feature database to perform identity authentication, and determining user identity information corresponding to the target feature data when the identity authentication is successful.

10. The device authentication method according to claim 9, wherein the comparing the target feature data with the target feature data in the identity feature database to perform identity authentication, and determining the user identity information corresponding to the target feature data when the identity authentication is successful comprises:
determining that the identity authentication is successful in a case that confidence of a comparison result between the target feature data and the target feature data in the identity feature database is greater than a second threshold.

11. The device authentication method according to claim 3, wherein the device authentication method comprises:
generating an authentication feedback request according to an authentication result or an identity authentication result; and
sending the authentication feedback request to a corresponding terminal device.

12. The device authentication method according to claim 3, wherein in a case that a plurality of terminal devices pass authentication, the server performs feature extraction on identity feature data corresponding to the plurality of terminal devices in a concurrent mode.

13. (canceled)

14. A computer device, wherein the computer device comprises one or more processors and a memory storing a computer program, in a case that the computer program is executed by the processors, acts of a device authentication method according to claim 1 are implemented.

15. A non-volatile computer-readable storage medium storing a computer program, wherein acts of a device authentication method according to claim 1 are implemented in a case that the computer program is executed by one or more processors.

16. The device authentication method according to claim 2, wherein the authentication request is sent by means of an Http Post request.

17. The device authentication method according to claim 3, wherein the authentication request is sent by means of an Http Post request.

18. A computer device, wherein the computer device comprises one or more processors and a memory storing a computer program, in a case that the computer program is executed by the processors, acts of a device authentication method according to claim 2 are implemented.

19. A computer device, wherein the computer device comprises one or more processors and a memory storing a computer program, in a case that the computer program is executed by the processors, acts of a device authentication method according to claim 3 are implemented.

20. A computer device, wherein the computer device comprises one or more processors and a memory storing a computer program, in a case that the computer program is executed by the processors, acts of a device authentication method according to claim 4 are implemented.

21. A computer device, wherein the computer device comprises one or more processors and a memory storing a computer program, in a case that the computer program is executed by the processors, acts of a device authentication method according to claim 5 are implemented.
